(19) United States
(12) Patent Application Publication
(10) Pub. No.: US 2009/0318223 A1
(43) Pub. Date: Dec. 24, 2009

(54) ARRANGEMENT FOR AUDIO OR VIDEO ENHANCEMENT DURING VIDEO GAME SEQUENCES

(75) Inventors: Adam J. Langridge, Guildford (GB); Russell Shaw, Guildford (GB)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/144,468

(22) Filed: Jun. 23, 2008

(51) Int. Cl. A63F 13/02; A63F 13/00

(52) U.S. Cl. 463/31; 463/35; 463/37

(57) ABSTRACT

An arrangement is provided which enhances video or audio effects, or both, in response to a notable event that occurs in video game to make the game experience for players more dramatic. Data about action events occurring in the video game may be used to determine if an action event corresponds to a notable event. If so, the data is used to generate and render at least one audio or video effect, or both, corresponding to the notable event. In various illustrative examples, the received data may correspond to an intensity of the action, a success of a subject player character, or the proximity to death of the subject player character. In addition to analyzing such parametric data, the notable event may be defined as one that corresponds to a predetermined action, such as a subject player character attacking another character or vice-versa, a subject player character entering a dungeon for instance, or a subject player character changing levels or zones.

### BACKGROUND

Computer and video games have matured from the likes of “Pong” into epic adventures having rich storylines, photorealistic graphics, and complex interaction systems, thereby allowing players to immerse themselves in the alternative reality that is emulated by the video game. As used herein, video games may include, but are not limited to, any game played on a data processing device. Examples of video games may include computer games, game console games (e.g., playable on the Microsoft Xbox®, Sony PlayStation®, and/or Nintendo® 64 and Wii brand game consoles), coin-operated or token-operated arcade games, portable gaming device games (e.g., playable on the PlayStation Portable (“PSP”®), Nintendo Game Boy and DS™, mobile phones, smartphones, personal digital assistants, etc.), or other software-driven games that are played on personal computers.

Video games come in many genres, such as first-person shooters (“FPS”), role-playing games (“RPG”), simulation, sports, strategy, and driving, to name a few. Each video game is not necessarily limited to a single genre, and may indeed encompass multiple genres. An RPG generally refers to a game in which each participant assumes the role of a character in the game (such as an adventurer, monster, or other character) that can interact within the game's virtual world. A character controlled by a player/user is commonly referred to as a player character.

In the FPS genre, the display screen typically provides a first person point of view, for example, as if the player is viewing the video game's virtual world through the eyes of the character the player is controlling. Popular FPS games include the HALO®, DOOM®, QUAKE®, and Half-Life® franchises. FPS games are very popular, in part because they are particularly well-suited to multiplayer game play.

In multiplayer play, each participant controls a player character within the virtual environment, and the participants either work alone or in teams to complete their objective(s) for a particular game. Multiplayer FPS games may provide different objectives in various game modes, thus providing a variety of game play types to participants. Some known multiplayer game modes include every-man-for-himself, every-team-for-itself, capture the flag, assault, and king of the hill. The every-man-for-himself format, referred to in the HALO franchise as Slayer mode, and referred to in the QUAKE franchise as Deathmatch mode, refers to a multiplayer game format in which each participant tries to kill all other participants in the graphically simulated virtual environment, for example, within a specific period of time.

The wide availability of Internet connectivity has fueled the popularity of multiplayer video gaming as players can use their on-line connection to locate other players and then participate in a common game. In the multiplayer video game, players can typically see and interact with player characters controlled by other players, even if the other players are physically located in another state or country.

Action in video games may range from tranquil scenes with little or no danger to a player's character up to massive boss battles where a character's death is imminent. Despite this rarge, and despite convergence in various aspects of video games and cinema, action in video games is often not as dramatic as that in films. Video game “cameras” are simple and static by design, in order to clearly represent the action. Musical backgrounds generally are not tied to the action. More dramatic scenes are generally reserved for heavily scripted events such as boss battles. Accordingly, it would be generally desirable to be able to bring more drama to video games to enrich the player's overall experience.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An arrangement is provided which enhances video or audio effects, or both, in response to a notable event that occurs in video game to make the game experience for players more dramatic. Data about action events occurring in the video game may be used to determine if an action event corresponds to a notable event. If so, the data is used to generate and render at least one audio or video effect, or both, corresponding to the notable event. In various illustrative examples, the received data may correspond to an intensity of the action, a success of a subject player character, or the proximity to death of the subject player character. In addition to analyzing such parametric data, the notable event may be defined as one that corresponds to a predetermined action, such as a subject player character attacking another character or vice-versa, a subject player character entering a dungeon for instance, or a subject player character changing levels or zones.

For example, the audio effect, which may be selected in some cases from a library of audio or video effects, may be a change of a quality of a musical score or a fade-in of a different musical score. The video effect may also be a desaturation of color, a zoom of a camera angle, a change of color levels, or a recomposition of a scene, for example, to provide a visualization of a more complete shot of a subject character and the character's surroundings, including opponents, as well as numerous other modifications.

Video or audio effects, or both, in a video game may be enhanced in response to a notable event using a music module to vary the music in a video game, a camera module to vary a camera angle, zoom, and the like, a graphics module to vary a color and quality of at least a portion of a game display, and a controller to receive data corresponding to action in the video game. In response to the data, the controller sends signals to the music module, the camera module, or the graphics module, or a combination thereof, to vary the audio or video rendering, or both, within the video game.

Advantageously, the present arrangement brings together the enhanced audio and video effects to heighten drama in the video game without impacting the gameplay itself. It thus enables the dramatic effects to be readily added to existing action sequences without compromising the flow or integrity of the sequence in any way.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative gaming system that may be used to implement one or more of the features of the arrangement described herein;

FIG. 2 shows a functional block diagram of the gaming system shown in FIG 1;

FIG. 3 shows a functional block diagram of an illustrative networked gaming system;

FIG. 4 shows a functional block diagram of an illustrative on-line gaming environment

FIGS. 5A-5C illustrate an illustrative time progression of scenes from a video game, as well as a graph indicating the rise and fall of certain variables related to action in the progression;

FIG. 6 shows a three-dimensional graph of various illustrative video game audio and video effects as functions of certain input variables relating to action in a video game;

FIG. 7 shows an illustrative main game sequence and an auxiliary sequence of audio and video effects;

FIG. 8 shows an illustrative schematic modular arrangement for enhancing audio or video effects in response to monitored action variables;

FIG. 9 shows details of the effect enhancement module within the arrangement of FIG. 8; and

FIG. 10 is a flowchart for an illustrative arrangement for enhancing effects in response to monitored action variables.

Like reference numerals indicate like elements in the drawings. Elements are not drawn to scale unless otherwise indicated.

### DETAILED DESCRIPTION

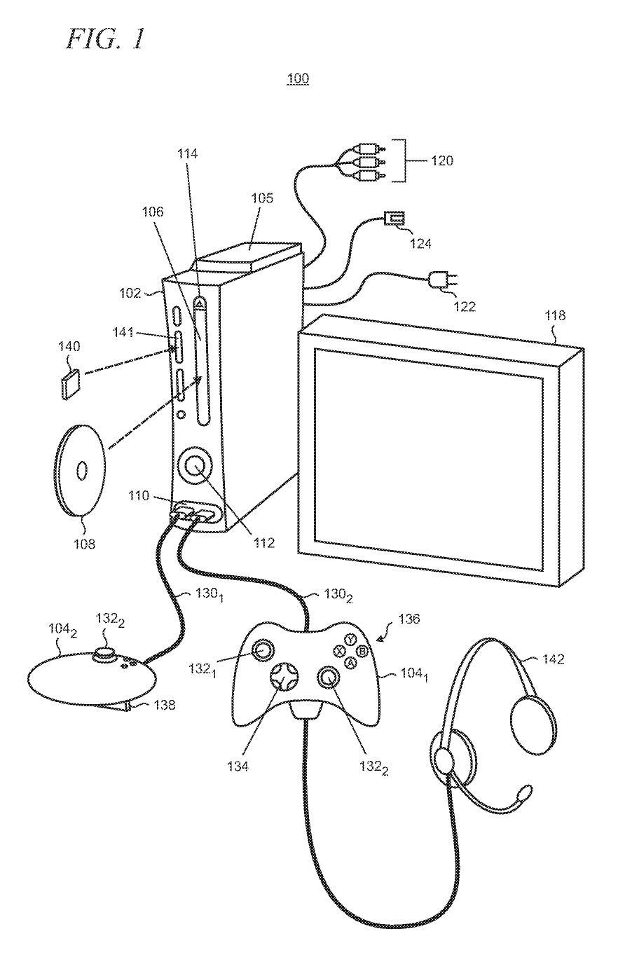

FIG. 1 illustrates an example of a gaming system 100 on which computer games, video games, and/or other electronic games (collectively referred to herein as video games) may be played. The gaming system 100 is only one example of a suitable gaming system and is not intended to suggest any limitation as to the scope of use or functionality ef the features described herein. Neither should the gaming system 100 be interpreted as having any dependency or requirement relating to any one or combination of components illustrated in the illustrative operating gaming system 100.

Aspects described herein are operational with numerous other general purpose or special purpose computing system environments or configurations. Examples of well-known computing systems, environments, and/or configurations that may be suitable for use include, but are not limited to, PCs, server computers, portable and hand-held devices such as personal digital assistants (“PDAs”), mobile phones, smartphones, handheld game devices, tablet PCs or laptop PCs, media centers, multiprocessor systems, microprocessor-based systems, set-top boxes, programmable consumer electronics, network PCs, minicomputers, mainframe computers, electronic game consoles, distributed computing environments that include any of the above systems or devices, and the like.

Aspects herein may be described in the general context of computer-executable instructions, such as program modules, being executed by a computer. Generally, program modules include routines, programs, objects, components, data structures, etc., that perform particular tasks or implement particular abstract data types. The features described herein may also be practiced in distributed computing environments where tasks are performed by remote processing devices that are linked through a communications network. In a distributed computing environment, program modules may be located in both local and remote computer storage media including memory storage devices.

The gaming system 100 may include a game console 102 and multiple controllers, as represented by controllers 104₁ and 104₂. The game console 102 is equipped with a removably attachable hard disk drive 105 and a portable media drive 106 that supports various forms of portable storage media as represented by optical storage disc 108. Examples of suitable portable storage media include DVD (digital versatile disc), CD-ROM (compact disc read only memory), game discs, and so forth.

Game console 102 has slots 110 on its front face to support up to two controllers, although the number and arrangement of slots may be modified. A power button 112 and an eject button 114 are also positioned on the front face of the game console 102. The power button 112 switches power to the game console and the eject button 114 alternately opens and closes a tray of the portable media drive 106 to allow insertion and extraction of the storage disc 108.

Game console 102 may connect to a television 118 or other display via A/V interfacing cables 120. A power cable 122 provides power to the game console. Game console 102 may further be configured with broadband network capabilities, as represented by the cable or modem connector 124 to facilitate access to a network, such as the Internet.

Each controller 104 may be coupled to the game console 102 via a wired or wireless interface. In the illustrated implementation, the controllers are USB (Universal Serial Bus) compatible and are connected to the console 102 via respective USB cables 130, and 1302. The controllers 104 may be equipped with any of a wide variety of user interaction mechanisms. In this example, each controller 104 is equipped with two thumbsticks 1321 and 1322, a D-pad (directional pad) 134, buttons 136 (e.g., ‘A’, ‘B’, ‘X’, ‘Y’), and two triggers 138 (although only one trigger is shown in the drawing). These mechanisms are merely representative, and other known gaming mechanisms may be substituted for or added to those shown in FIG. 1.

A memory unit 140 may be inserted into a memory unit reader 141 in the game console 102 to provide additional and portable storage. In this example, up to two memory units may be supported by the game console 102. Portable memory units enable users to store game parameters and user accounts, and port them for play on other consoles. A headset 142 may be connected to the controller 104 or game console 102 to provide audio communication capabilities. Headset 142 may include a microphone for audio input and one or more speakers for audio output.

Gaming system 100 is capable of playing, for example, games, music, and videos. With the different storage offerings, titles can be played from the hard disk drive or the portable media 108 in drive 106, from an online source, or from a memory unit 140. For security, in some embodiments executable code can only be run from the portable media 108. A sample of what gaming system 100 is capable of playing includes game titles played from CD and DVD discs, from the hard disk drive, or from an online source, digital music played from a CD in the portable media drive 106, from a file on the hard disk drive (e.g., Windows Media Audio (“WMA”) format), or from online streaming sources, and digital audio/video played from a DVD disc in the portable media drive 106, from a file on the hard disk drive (e.g., Active Streaming Format), or from online streaming sources.

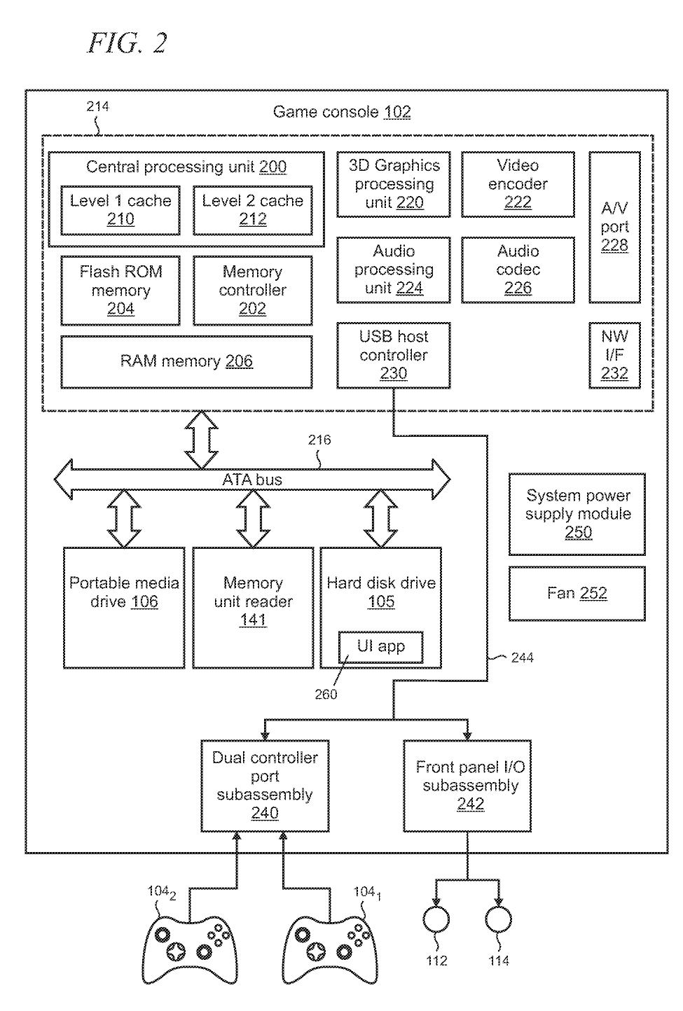

FIG. 2 shows functional components of the gaming system 100 in more detail. The game console 102 has a central processing unit (“CPU”) 200 and a memory controller 202 that facilitates processor access to various types of memory, including a flash ROM (Read Only Memory) 204, a RAM (Random Access Memory) 206, the hard disk drive 105, the memory unit reader 141, and the portable media drive 106. The CPU 200 is equipped with a level 1 cache 210 and a level 2 cache 212 to temporarily store data and hence reduce the number of memory access cycles, thereby improving processing speed and throughput.

The CPU 200, memory controller 202, and various memory devices are interconnected via one or more buses, including serial and parallel buses, a memory bus, a peripheral bus, and a processor or local bus using any of a variety of bus architectures. By way of example, such architectures can include an Industry Standard Architecture (“ISA”) bus, a Micro Channel Architecture (“MCA”) bus, an Enhanced ISA (“EISA”) bus, a Video Electronics Standards Association (“VESA”) local bus, and a Peripheral Component Interconnects (“PCI”) bus also known as a Mezzanine bus.

As one suitable implementation, the CPU 200, memory controller 202, ROM 204, and RAM 206 are integrated onto a common module 214. In this implementation, ROM 204 is configured as a flash ROM that is connected to the memory controller 202 and a ROM bus (not shown). RAM 206 is configured as multiple DDR SDRAM (Double Data Rate Synchronous Dynamic RAM) that is independently controlled by the memory controller 202 via separate buses (not shown). The hard disk drive 105 and portable media drive 106 are connected to the memory controller via the PCI bus and an ATA (Advanced Technology Attachment) bus 216.

A 3D graphics processing unit 220 and a video encoder 222 form a video processing pipeline for high speed and high resolution graphics processing. Data is carried from the graphics processing unit 220 to the video encoder 222 via a digital video bus (not shown). An audio processing unit 224 and an audio codec (coder/decoder) 226 form a corresponding audio processing pipeline with high fidelity and stereo processing. Audio data is carried between the audio processing unit 224 and the audio codec 226 via a communication link (not shown). The video and audio processing pipelines output data to an A/V (audio/video) port 228 for transmission to the television or other display. In the illustrated implementation, the video and audio processing components 220-228 are mounted on the module 214.

Also implemented on the module 214 are a USB host controller 230 and a network interface 232. The USB host controller 230 is coupled to the CPU 200 and the memory controller 202 via a bus (e.g., PCI bus) and serves as host for the peripheral controllers 104₁ and 104₂. The network interface 232 provides access to a network (e.g., Internet, home network, etc.) and may be any of a wide variety of various wired or wireless interface components including an Ethernet card, a modem, a Bluetooth module, a cable modem, and the like.

The game console 102 has a dual controller port subassembly 240 which supports the game controllers 104₁ and 104₂. A front panel I/O subassembly 242 supports the functionality of the power button 112 and the eject button 114, as well as any LEDs (light emitting diodes) or other indicators exposed on the outer surface of the game console. The subassemblies 240 and 242 are coupled to the module 214 via one or more cable assemblies 244.

A system power supply module 250 provides power to the components of the gaming system 100. A fan 252 cools the circuitry within the game console 102.

The game console 102 implements a uniform media portal model that provides a consistent user interface and navigation hierarchy to move users through various entertainment areas. The portal model offers a convenient way to access content from multiple different media types—game data, audio data, and video data—regardless of the media type inserted into the portable media drive 106.

To implement the uniform media portal model, a console user interface (“UI”) application 260 is stored on the hard disk drive 105. When the game console is powered on, various portions of the console application 260 are loaded into RAM 206 and/or caches 210 and 212 and executed on the CPU 200. The console application 260 presents a graphical user interface that provides a consistent user experience when navigating to different media types available on the game console.

The gaming system 100 may be operated as a standalone system by simply connecting the system to a television or other display. In this standalone mode, the gaming system 100 allows one or more players to play games, watch movies, or listen to music. However, with the integration of broadband connectivity made available through the network interface 232, the gaming system 100 may further be operated as a participant in a larger network gaming community. This network gaming environment is described next.

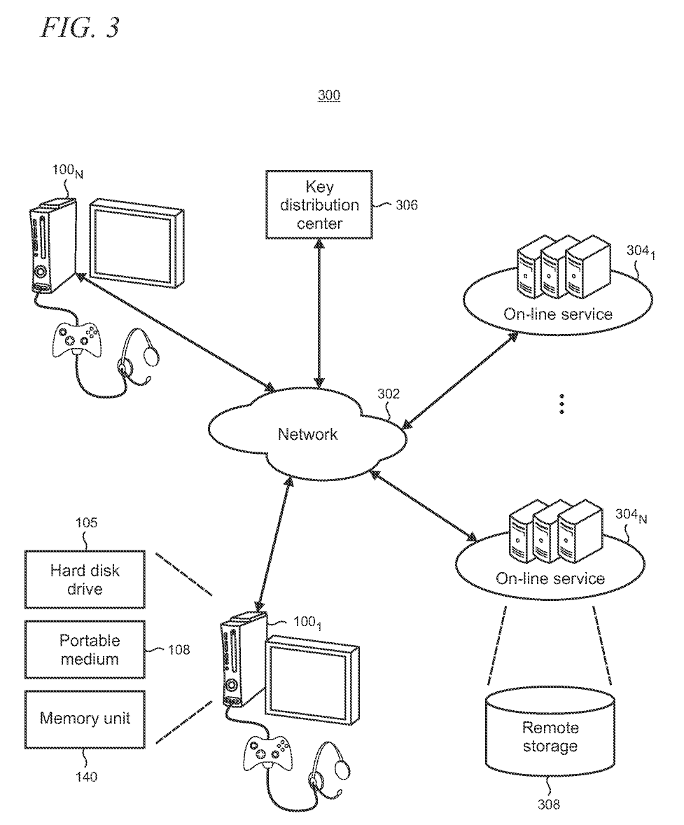

FIG. 3 shows an exemplary network gaming environment 300 that interconnects multiple gaming systems 100_{1 . . . N} via a network 302. The network 302 represents any of a wide variety of data communications networks. It may include public portions (e.g., the Internet) as well as private portions (e.g., a residential Local Area Network (“LAN”)), as well as combinations of public and private portions. Network 302 may be implemented using any one or more of a wide variety of conventional communications media including both wired and wireless media. Any of a wide variety of communications protocols can be used to communicate data via network 302, including both public and proprietary protocols. Examples of such protocols include TCP/IP (Transport Control Protocol/Internet Protocol), IPX/SPX (Internetwork Packet Exchange/Sequenced Packet Exchange), NetBEUI (NetBIOS Extended User Interface where BIOS stands for Basic Input/Output System), etc.

In addition to gaming systems 100, one or more online services 304_{1 . . . N} may be accessible via the network 302 to provide various services for the participants, such as hosting online games, serving downloadable music or video files, hosting gaming competitions, serving streaming audio/video files, and the like. The network gaming environment 300 may further involve a key distribution center 306 that plays a role in authenticating individual players and/or gaming systems 100 to one another as well as online services 304. The distribution center 306 distributes keys and service tickets to valid participants that may then be used to form games amongst multiple players or to purchase services from the online services 304.

The network gaming environment 300 introduces another memory source available to individual gaming systems 100, namely online storage. In addition to the portable media 108, the hard disk drive 105, and the memory unit(s) 140, the gaming systems 100 can also access data files available at remote storage locations via the network 302, as exemplified by remote storage 308 at online service 304_{N}.

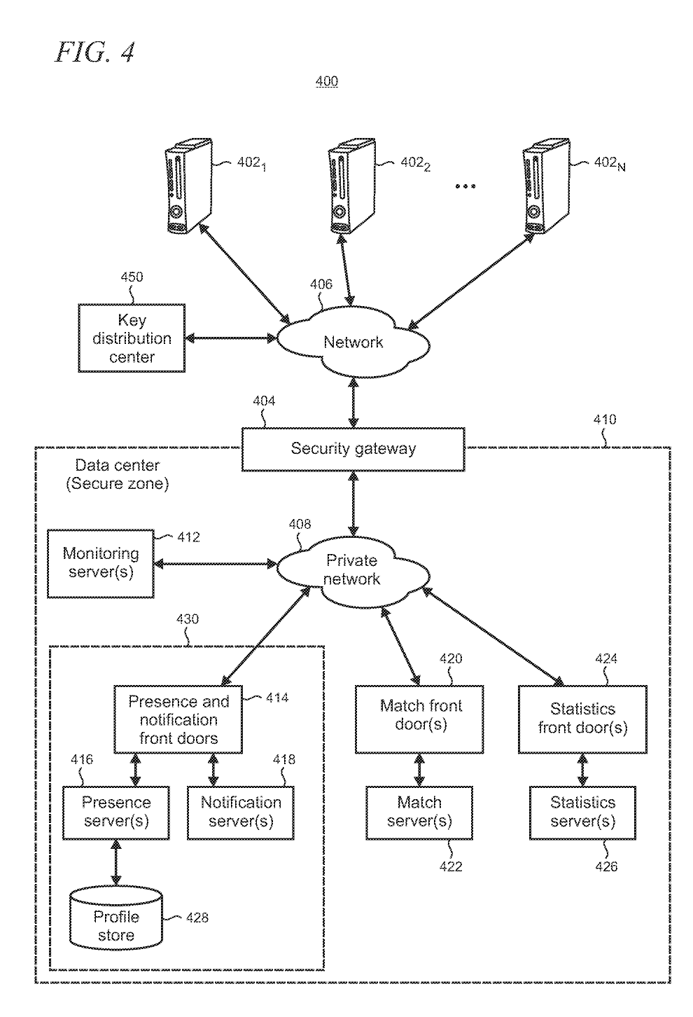

FIG. 4 is a block diagram of another illustrative online gaming environment 400, for example, XBOX® 360 by Microsoft Corporation. Multiple game consoles 402_{1, 2 . . . N} are coupled to a security gateway 404 via a network 406. Each game console 402 can be configured in a similar manner as game console 102 of FIG. 1 or FIG. 2, for example. Network 406 represents any one or more of a variety of conventional data communications networks. Network 406 will typically include packet switched networks, but may also include circuit switched networks. Network 406 can include wired and/or wireless portions. In one exemplary implementation, network 406 includes the Internet and may optionally include one or more local area networks and/or wide area networks (“WANs”). At least a part of network 406 is a public network, which refers to a network that is publicly-accessible.

In some situations, network 406 includes a LAN (e.g., a home network), with a routing device situated between game console 402 and security gateway 404. This routing device may perform network address translation (“NAT”), allowing the multiple devices on the LAN to share the same IP address on the Internet, and to operate as a firewall to protect the device(s) on the LAN from access by malicious or mischievous users via the Internet.

Security gateway 404 operates as a gateway between public network 406 and a private network 408. Private network 408 can be any of a wide variety of conventional networks, such as a local area network. Private network 408, as well as other devices discussed in more detail below, is within a data center 410 that operates as a secure zone. Data center 410 is made up of trusted devices that communicate using trusted communications. Thus, encryption and authentication within secure zone 410 is not necessary. The private nature of network 408 refers to the restricted accessibility of network 408 such that access to network 408 is limited to only certain individuals (e.g., restricted by the owner or operator of data center 410).

Security gateway 404 is a cluster of one or more security gateway computing devices. These security gateway computing devices collectively implement security gateway 404. Security gateway 404 may optionally include one or more conventional load balancing devices that operate to direct requests to be handled by the security gateway computing devices to appropriate ones of those computing devices. This directing or load balancing is performed in a manner that attempts to balance the load on the various security gateway computing devices approximately equally (or alternatively in accordance with some other criteria).

Also within data center 410 are: one or more monitoring servers 412, one or more presence and notification front doors 414, one or more presence servers 416, one or more notification servers 418, and a profile store 428 (collectively implementing a presence and notification service or system 430), one or more match front doors 420 and one or more match servers 422 (collectively implementing a match service), and one or more statistics front doors 424 and one or more statistics servers 426 (collectively implementing a statistics service). The servers 416, 418, 422, and 426 provide services to game consoles 402, and thus can be referred to as service devices. Other service devices may also be included in addition to, and/or in place of, one or more of the servers 416, 418, 422, and 426. Additionally, although only one data center is shown in FIG. 4, alternatively, multiple data centers may exist with which game consoles 402 can communicate. These data centers may operate independently, or alternatively may operate collectively (e.g., to make one large data center available to the game consoles 102 and 402).

Game consoles 402 are situated remotely from data center 410, and may access data center 410 via network 406. A game console 402, desiring to communicate with one or more devices in the data center, logs in to the data center and establishes a secure communication channel between the game console 402 and security gateway 404. Game console 402 and security gateway 404 encrypt and authenticate data packets being passed back and forth, thereby allowing the data packets to be securely transmitted between them without being understood by any other device that may capture or copy the data packets without breaking the encryption. Each data packet communicated from game console 402 to security gateway 404, or from security gateway 404 to game console 402, can have data embedded therein. This embedded data is referred to as the content or data content of the packet. Additional information may also be inherently included in the packet based on the packet type (e.g., a heartbeat packet).

The secure communication channel between a game console 402 and security gateway 404 is based on a security ticket. Game console 402 authenticates itself and the current user(s) of console 402 to a key distribution center 450 and obtains, from key distribution center 450, a security ticket. Game console 402 then uses this security ticket to establish the secure communication channel with security gateway 404. In establishing the secure communication channel with security gateway 404, the game console 402 and security gateway 404 authenticate themselves to one another and establish a session security key that is known only to that particular game console 402 and the security gateway 404. This session security key is used to encrypt data transferred between the game console 402 and the security gateway 404, so no other devices (including other game consoles 402) can read the data. The session security key is also used to authenticate a data packet as being from the security gateway 404 or game console 402 that the data packet alleges to be from. Thus, using such session security keys, secure communication channels can be established between the security gateway 404 and the various game consoles 402.

Once the secure communication channel is established between a game console 402 and the security gateway 404, encrypted data packets can be securely transmitted between the two. When the game console 402 desires to send data to a particular service device in data center 410, the game console 402 encrypts the data and sends it to security gateway 404 requesting that it be forwarded to the particular service device(s) targeted by the data packet. Security gateway 404 receives the data packet and, after authenticating and decrypting the data packet, encapsulates the data content of the packet into another message to be sent to the appropriate service via private network 408. Security gateway 404 determines the appropriate service for the message based on the requested service(s) targeted by the data packet.

Similarly, when a service device in data center 410 desires to communicate data to a game console 402, the data center sends a message to security gateway 404, via private network 408, including the data content to be sent to the game console 402 as well as an indication of the particular game console 402 to which the data content is to be sent. Security gateway 404 embeds the data content into a data packet, and then encrypts the data packet so it can only be decrypted by the particular game console 402 and also authenticates the data packet as being from the security gateway 404.

Although discussed herein as primarily communicating encrypted data packets between security gateway 404 and a game console 402, alternatively, some data packets may be partially encrypted (some portions of the data packets are encrypted while other portions are not encrypted). Which portions of the data packets are encrypted and which are not can vary based on the desires of the designers of data center 410 and/or game consoles 402. For example, the designers may choose to allow voice data to be communicated among consoles 402 so that users of the consoles 402 can talk to one another—the designers may further choose to allow the voice data to be unencrypted while any other data in the packets is encrypted. Additionally, in another alternative, some data packets may have no portions that are encrypted (that is, the entire data packet is unencrypted). It is also noted that, even if a data packet is unencrypted or only partially encrypted, all of the data packet can still be authenticated.

Each security gateway device in security gateway 404 is responsible for the secure communication channel with typically one or more game consoles 402, and thus each security gateway device can be viewed as being responsible for managing or handling one or more game consoles. The various security gateway devices may be in communication with each other and communicate messages to one another. For example, a security gateway device that needs to send a data packet to a game console that it is not responsible for managing may send a message to all the other security gateway devices with the data to be sent to that game console. This message is received by the security gateway device that is responsible for managing that game console and the device in turns sends the appropriate data to that game console. Alternatively, the security gateway devices may be aware of which game consoles are being handled by which security gateway devices—this awareness may be explicit, such as each security gateway device maintaining a table of game consoles handled by the other security gateway devices, or alternatively, implicit, such as determining which security gateway device is responsible for a particular game console based on an identifier of the game console.

Monitoring server(s) 412 operate to inform devices in data center 410 of an unavailable game console 402 or an unavailable security gateway device of security gateway 404. Game consoles 402 can become unavailable for a variety of different reasons, such as a hardware or software failure, the console being powered-down without logging out of data center 410, the network connection cable to console 402 being disconnected from console 402, other network problems (e.g., the LAN that the console 402 is on malfunctioning), etc. Similarly, a security gateway device of security gateway 404 can become unavailable for a variety of different reasons, such as hardware or software failure, the device being powered-down, the network connection cable to the device being disconnected from the device, other network problems, etc.

Each of the security gateway devices in security gateway 404 is monitored by one or more monitoring servers 412, which detect when one of the security gateway devices becomes unavailable. In the event a security gateway device becomes unavailable, monitoring server 412 sends a message to each of the other devices in data center 410 (servers, front doors, etc.) that the security gateway device is no longer available. Each of the other devices can operate based on this information as it sees fit (e.g., it may assume that particular game consoles being managed by the security gateway device are no longer in communication with data center 410 and perform various clean-up operations accordingly). Alternatively, only certain devices may receive such a message from the monitoring server 412 (e.g., only those devices that are concerned with whether security gateway devices are available).

Security gateway 404 monitors the individual game consoles 402 and detects when one of the game consoles 402 becomes unavailable. When security gateway 404 detects that a game console is no longer available, security gateway 404 sends a message to monitoring server 412 identifying the unavailable game console. In response, monitoring server 412 sends a message to each of the other devices in data center 410 (or alternatively only selected devices) that the game console is no longer available. Each of the other devices can then operate based on this information as it sees fit.

Presence server(s) 416 holds and processes data concerning the status or presence of a given user logged in to data center 410 for online gaming. Notification server(s) 418 maintains multiple notification queues of outgoing messages destined for a player logged in to data center 410. Presence and notification front door 414 is one or more server devices that operate as an intermediary between security gateway 404 and servers 416 and 418. One or more load balancing devices (not shown) may be included in presence and notification front door 414 to balance the load among the multiple server devices operating as front door 414.

Security gateway 404 communicates messages for servers 416 and 418 to the front door 414, and the front door 414 identifies to which particular presence server 416 or particular notification server 418 the message is to be communicated. By using front door 414, the actual implementation of servers 416 and 418, such as which servers are responsible for managing data regarding which users, is abstracted from security gateway 404. Security gateway 404 can simply forward messages that target the presence and notification service to presence and notification front door 414 and rely on front door 414 to route the messages to the appropriate one of server(s) 416 and server(s) 418.

Match server(s) 422 holds and processes data concerning the matching of online players to one another. An online user is able to advertise a game available for play along with various characteristics of the game (e.g., the location where a football game will be played, whether a game is to be played during the day or at night, the user's skill level, etc.). These various characteristics can then be used as a basis to match up different online users to play games together. Match front door 420 includes one or more server devices (and optionally a load balancing device(s)) and operates to abstract match server(s) 422 from security gateway 404 in a manner analogous to front door 414 abstracting server(s) 416 and server(s) 418.

Statistics server(s) 426 holds and processes data concerning various statistics for online games. The specific statistics used can vary based on the game designer's desires (e.g., the top ten scores or times, a world ranking for all online players of the game, a list of users who have found the most items or spent the most time playing, etc.). Statistics front door 424 includes one or more server devices (and optionally a load balancing device(s)) and operates to abstract statistics server(s) 426 from security gateway 404 in a manner analogous to front door 414 abstracting server(s) 416 and server(s) 418.

Thus, it can be seen that security gateway 404 operates to shield devices in the secure zone of data center 410 from the untrusted public network 406. Communications within the secure zone of data center 410 need not be encrypted, as all devices within data center 410 are trusted. However, any information to be communicated from a device within data center 410 to a game console 402 passes through security gateway cluster 404, where it is encrypted in such a manner that it can be decrypted by only the game console 402 targeted by the information.

One or more features described herein may be embodied in computer-executable instructions (i.e., software) stored in RAM 206, non-volatile memory 108, 105, 308, or any other resident memory on game console 102. Generally, software modules include routines, programs, objects, components, data structures, etc. that perform particular tasks or implement particular abstract data types when executed by a processor in a computer or other device. The computer executable instructions may be stored on a computer readable medium such as one or more hard disks 105, portable storage media 108 (e.g., CD-ROM, DVD, disk, etc.), solid state memory, RAM 206, etc. As will be appreciated by one of skill in the art, the functionality of the software modules may be combined or distributed as desired in various embodiments. In addition, the functionality may be embodied in whole or in part in firmware or hardware equivalents such as application specific integrated circuits (“ASIC”), field programmable gate arrays (“FPGA”), and the like.

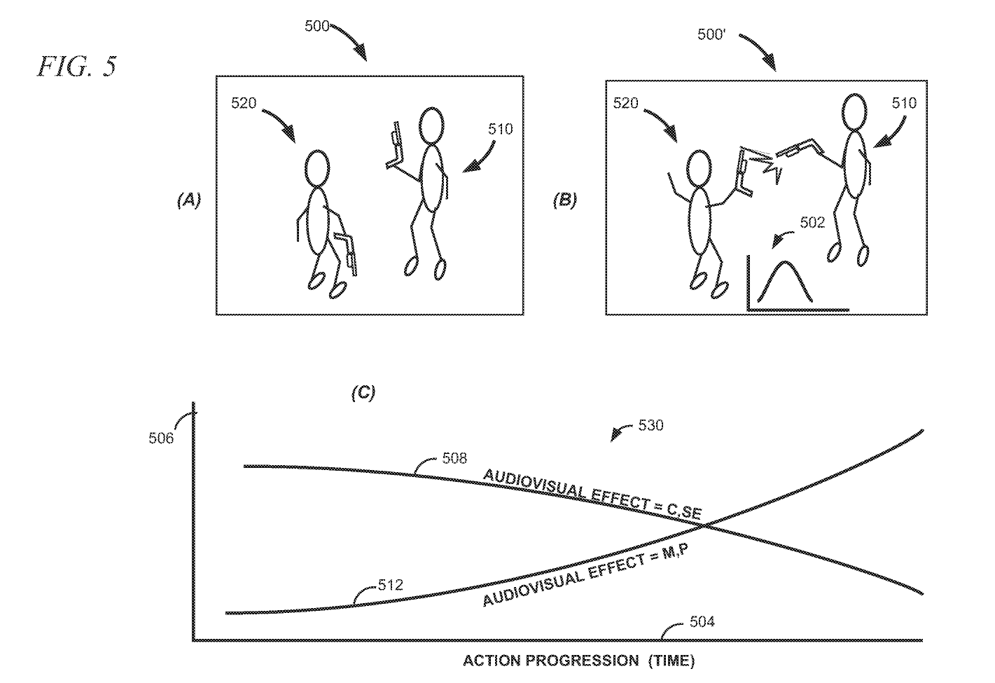

Turning now to FIGS. 5A-C, an environment is shown which may employ an arrangement for enhancing effects in a video game. FIGS. 5A and 5B show two scenes of an action sequence, scene 500, and then scene 500′ which takes play shortly thereafter in the game time. Such scenes are generally rendered on a user interface, i.e., the game display, and are from the point of view of a player-modifiable main game camera. The player can generally move the point of view of the main game camera or its zoom or both. In this respect, it is noted that in some cases a default camera position may be, for example, about three meters behind the subject player character, and about two-and-a-half meters high.

Each scene has two characters therein, character 510 and character 520, though of course any number of characters may be situated in the scene. In many cases one of the characters will be controlled by a user, in particular the user who is viewing scenes 500 and 500′. In some cases, scenes 500 and 500′ are playbacks of a movie or video clip as recorded by a third party, or recorded by the user who had controlled character 510 or 520, and so neither character is being controlled at the time of viewing.

While generally a user is controlling one of the characters 510 and 520, the other of the characters may be controlled by another player or may be computer-controlled, i.e., may be a non-player character. Finally, it is noted that a player or user need not control just one player character—rather, the same may control a group of player characters, a zone of player characters, or the like. In addition, multiple players may control multiple respective characters within the scene.

In scene 500, the player character 510 is displayed as being about to level a weapon at the player character (or non-player character) 520. In FIG. 5, the weapon is a gun. It will be clear that such an attack (or indeed any other interaction between characters) may be levied in countless ways. In scene 500′, the player character 510 is firing the weapon at the player character 520. The act of firing the weapon necessarily heightens the action level of the scene, and arrangements described here enhance the audio or video effects of the scene, or both, in response to this heightened impact. Of course, any number of actions may give rise to such heightened impact. Moreover, any number of parameters corresponding to a player character may give rise to a heightened impact and thus may invoke the arrangement. Where an action gives rise to this heightened impact, or where a parameter goes beyond a predetermined threshold and in this way gives rise to a heightened impact, a “notable event” has occurred as the term is used here.

In some implementations, the spectrum of notable events is very broad, and in this case most any action can cause an enhanced video or audio effect. Most actions will then cause minor variations in the video or audio tracks, while major actions, for example, battle sequences, may cause much more substantial variations. In other implementations, only particularly intense actions will cause variations in otherwise default-type audio or video sequences.

A notable event for one user (or player character) may not be notable for another, or may alternatively be notable in a different way. For example, in FIG. 5(B), the firing of a weapon by player character 510 is indicated by an action intensity graph 502. The x-axis of the graph 502 may be, for example time or a time-related variable. The y-axis may be a number of different variables, some of which are at least partially related to each other. The maximum of the curve in graph 502 is positioned under the gun firing to indicate a presumed maximum of action intensity at that point. Consequently, an audio or video effect, such as a drum crash or drum roll, may have a corresponding maximum at this point, or one related to this point. In this way, the overall impact of the notable event is enhanced, and the immersive experience of the user is increased.

While specific effects are noted below, here it is noted that audio effects may include both those related to music effects as well as those related to sound effects. Video effects may include, for example, specific camera angles or “procedural cuts”, recompositions to include more or less characters, color effects, desaturation effects, tunnel-vision effects, or the like.

FIG. 5(C) illustrates a graph 530 of resulting audio or video effects (curves 508 and 512 as measured on y-axis 506) as a function of time (x-axis 504). The curves 508 and 512 are generally intended to track the action displayed above in scenes 500 and 500′. As the scenes progress from moderate to high intensity, one set of audio and video effects (curve 512, relating to music (M) and procedural cuts (P)) increases, while another (curve 508, relating to camera (C) and special effects (SE)) decreases. These are purely exemplary and may be arbitrarily set to whatever the designer desires. They are noted here only as examples.

In particular, as the action increases, the camera angle may decrease in order to just show a subject player character, i.e., that which is controlled by the user viewing the scene, as well as the object of the subject player character's attack (or that which has attacked the subject player character). In the same way, the special effects may decrease: the color may desaturate in order to only visualize, in color, the subject player character and the enemy, as well as, for example, blood effects. Everything else may appear in black and white. In this way, the primary “actors” are emphasized. Conversely, the music may swell as the battle progresses, indicated by a rising curve 512. Similarly, the procedural cuts may result in a camera recomposing the shot to include more enemies, even as the overall camera angle decreases.

Such effects may be simple to quantify, but the number of ways in which to perform the quantification may be numerous. Accordingly, a general description is given here, along with certain examples. Numerous variations will be seen from this description.

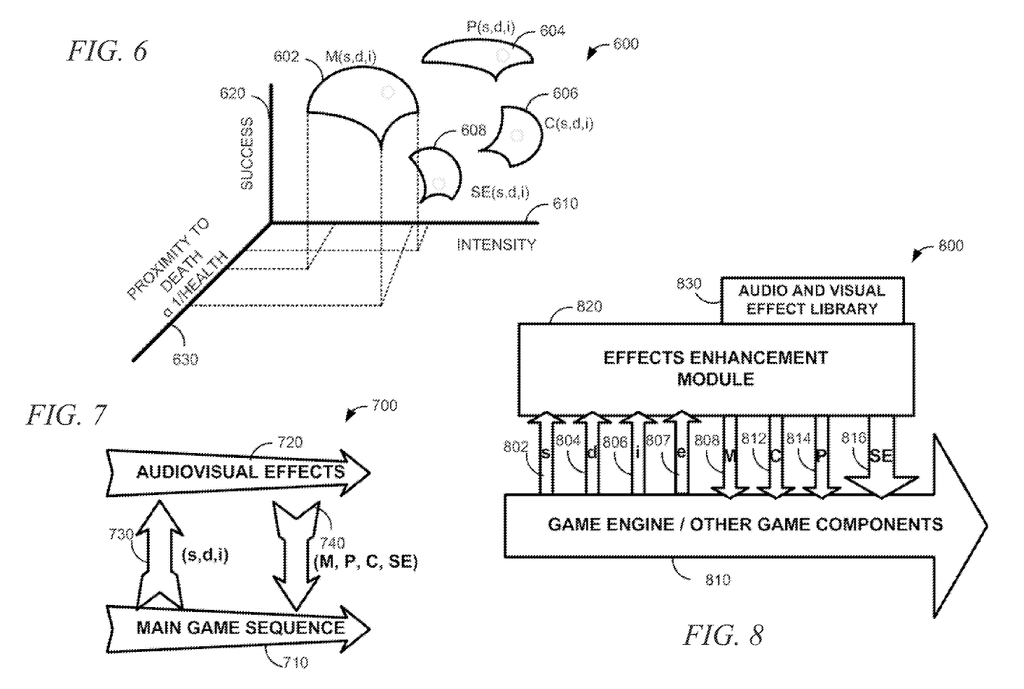

Referring now to FIG. 6, a three-dimensional graph 600 is illustrated which indicates an action space whose coordinates may define various audio or video effects. Three coordinates are shown, intensity “i” measured on axis 610, success “s” measured on axis 620, and proximity to death “d” measured on axis 630. At least some combinations of these variables may be mapped to elements that control audio or video effects. In FIG. 6, a music function M is a function of these variables, for example, M(s,d,i) (curve 602), as are special effects SE(s,d,i) 608, camera C(s,d,i) 606, and procedural cuts P(s,d,i) 604. Each of these functions may be discrete or continuous, and each may represent a surface or volume in the “action space” defined by the basis variables. Each point on the defined surface or volume then has a value, and the value corresponds to a music effect, special effect, procedural cut effect, or camera effect. It is noted that other effects may also be utilized to meet the needs of a particular implementation.

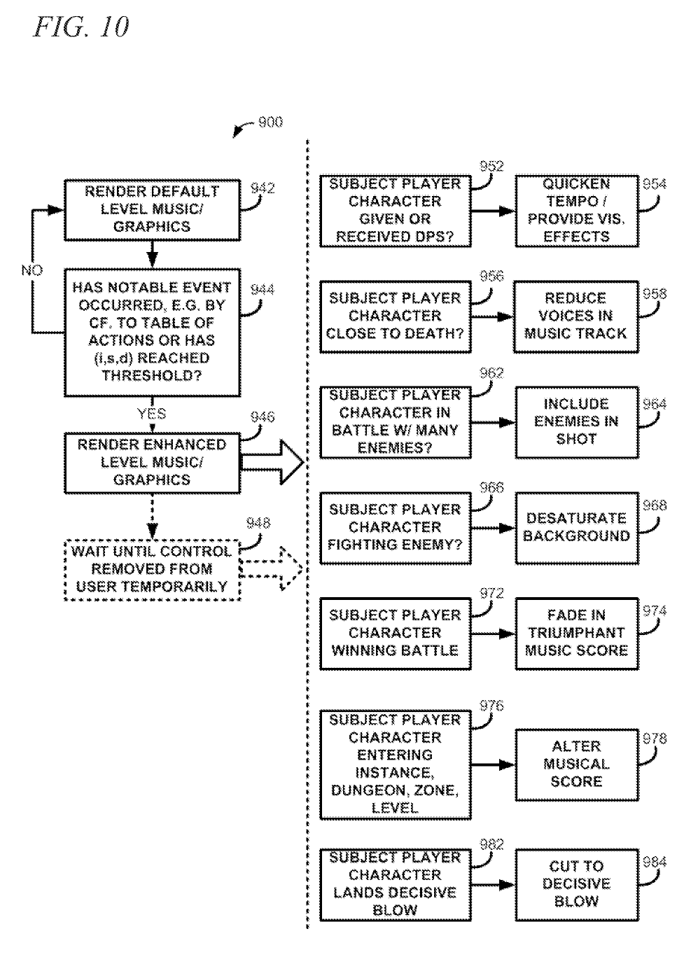

The abscissas or independent variables (s,d,i) may be defined in a number of ways. Certain of these, and their corresponding ordinates or dependent variables, are noted in the Table below as well as in FIG. 10. For example, intensity i may correspond to the number of opponents being faced by a subject player character in a battle or fight, as well as the opponent's respective levels or fighting skill attributes, or both, as compared to the level and attributes of the subject player character. Success s may be defined by tracking how often a subject player character has landed successful hits on opponents relative to their reception of damage, for example, “damage per second” (DPS) given versus received. The proximity of death is generally inversely related to a health parameter of the subject player character, but may also be affected by various spells or buffs currently affecting the subject player character.

TABLE

| | | | Special | Procedural | “Direction” |
|---|---|---|---|---|---|
| Variable | Music (M) | Camera (C) | Effects (SE) | Cuts (P) | of variable |
| Intensity | Increase volume, | Include more | Develop | Cut to best- | [symbol] |
| (i) | tempo | relevant | ‘tunnel’ view | view scenes | |
| | | objects/ | | | |
| | | characters | | | |
| | Decrease to | Pan back to | Decrease to | Pan back to | [symbol] |
| | default level | default or | default levels | default or | |
| | | prior view | | prior view | |
| Proximity | Make ‘tinnier’, | Focus on | Desaturate | Cut to attacks | [symbol] |
| to death | reduce number of | subject player | color, except | on subject | |
| (d) | voices | character | for subject | player | |
| | | | player | character | |
| | | | character, | | |
| | | | opponent, | | |
| | | | blood | | |
| | Decrease to | Pan back to | Decrease to | Pan back to | [symbol] |
| | default level | default or | default levels | default or | |
| | | prior view | | prior view | |
| Success | Fade in triumphal | Focus on | Emphasize | Show cuts of | [symbol] |
| (s) | music | enemy or | subject player | critical | |
| | | target | character color | attacks | |
| | | | intensity | | |
| | Decrease to | Pan back to | Decrease to | Pan back to | |
| | default level | default or | default levels | default or | |
| | | prior view | | prior view | |

The outputs are based on the input variables. For example, a video game music score generally includes several tracks that are combined to result in the final sound made by a sound renderer. Depending on the action space coordinate, the music effects M(s, d, i) output may result in different tracks being faded in or out, or stopped altogether. Alternatively, more tracks may be added. In other words, the score is reactive to the flow of action. As another example, as a subject player character's health decreases, the score may be made “tinnier”, with a reduced number of voices, to emphasize in an audio way the nearness of the subject player character's demise.

Similarly, also depending on the action space coordinate, the main gameplay camera, indicated by C(s,d,i), may be affected so as to, for example, change the camera angle from a default position to a tight shot to focus on the subject player character, change the zoom in order to give an impression of low health, recompose the shot to include more opponents, or the like.

A procedural cut effects output P(s, d, i) may be employed to vary the camera cut or shot depending on the certain dramatic events, for example to portray opponents arriving, special attacks, particularly devastating or critical attacks, or the like. Such may be employed for any scene with impressive or otherwise notable visual content, and may employ a library of pre-rendered audio or video from which to draw to display such scenes. In this way, the cinematic video style may be made reactive to the flow of action.

A special screen effects output SE(s,d,i) may be employed to, for example, vary the color balance levels of the final image rendered to the screen along with other special effects. In this way, the rendering style is made reactive to the flow of action.

The above effects, and the example descriptions of each, are purely exemplary and may be changed to suit the situation for any game, for example, to pertain to a given game genre, style, or the like.

Referring to FIG. 7, a data flow diagram 700 is shown for a main game sequence 710 and for an auxiliary sequence 720 for audio or video effects. Each may flow independently, though each affects the operation of the other. In particular, the audio or video effects sequence 720 receives data 730 from the main game sequence 710, and the audio or video effects sequence 720 drives certain outputs 740 of the main game sequence 710.

FIG. 8 shows a modular schematic diagram of an arrangement 800. A game engine, in combination with various other game components, is shown as game engine 810. The game engine 810 is in data communication with the effects enhancement module 820.

The effects enhancement module 820 may have access to an audio and video effect library 830, which may contain scripted events, pre-rendered audio or video, or other event information which may be called upon and to which access is desirable. The audio and video effect library 830 may be a separate module as shown or it may be a module within the effects enhancement module 820. The pre-rendered audio or video may pertain to events that occur in generally a few number of ways, and for which it may be desired to have particularly spectacular effects, for example, the death of a major boss or the like.

Exemplary data streams are shown from the game engine 810 to the effects enhancement module 820. These data streams may be measured in the ways indicated above, or in any other suitable way. They include success data 802, proximity to death data 804, and intensity data 806. Other parameters may also be monitored. The data stream may also include information about specific events that have occurred in the ongoing action, this data stream indicated by event data 807. The event data 807 generally includes descriptions of specific events as they occur, for example, “subject player character attacks opponent”, or “opponent attacks subject player character” or the like. This event data is then compared to a table of notable events to determine if the event in the data stream 807 rises to the level of a notable event for which the effects enhancement module 820 should provide an enhanced effect.

The effects enhancement module 820 analyzes the incoming data streams to determine if an audio or video enhancement, or both, is called for. The analysis is performed by various algorithms. Various exemplary data points which may be calculated by the algorithms are described above as well as in FIG. 10 and in the appended Table. Of course, the algorithms may be replaced by a series of rules which map inputs to appropriate outputs. In FIG. 8, the outputs include a music output 808, a camera output 812, a procedural cuts output 814, and a special effects output 816.

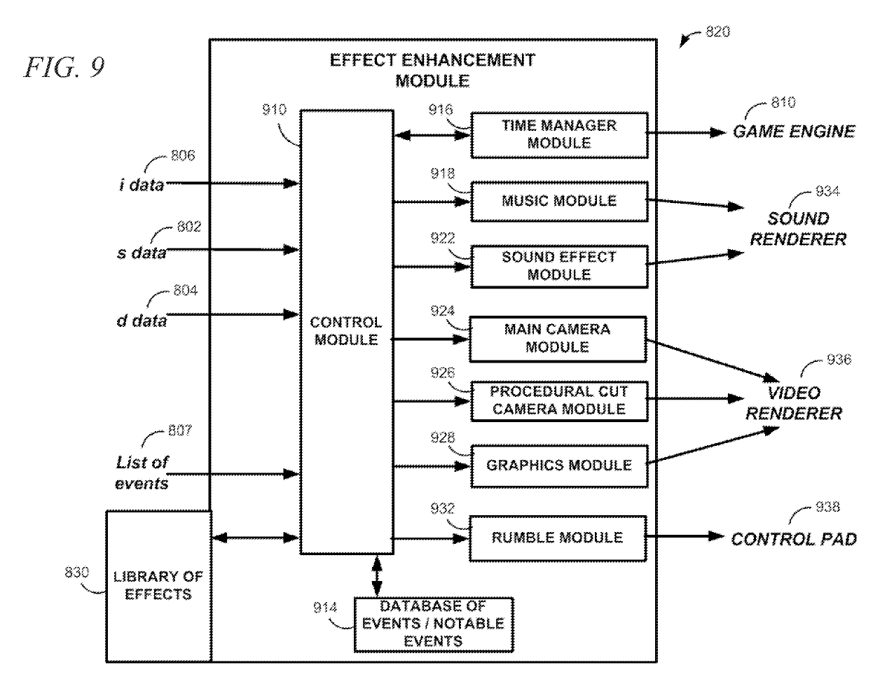

FIG. 9 illustrates additional details of the enhancement module 820. The enhancement module 820 includes a control module 910 which takes as inputs the success data 802, proximity to death data 804, and intensity data 806, as well as event data 807, and performs an analysis to determine what effect enhancements should be caused. As noted, the control module may access a table or database of notable events, shown in FIG. 9 as database 914. Like the library 830, the database 914 may be located within the enhancement module 820 (as shown) or may be a separate module. The control module 910 communicates with a time manager module 916, and further drives various output modules. In some embodiments the control module 910 may be combined with the time manager module 916.

The time manager module 916 coordinates when various effects may be rendered, for example, at which point in the action the particular effect should be rendered in order to provide an enhanced effect. The time manager module 916 may also coordinate effect delivery such that effects may be caused to happen when user inputs are at a minimum, for example, when user controls are inhibited because a video sequence is being played back, and so on. In other words, during certain parts of action sequences, the user may be prohibited from providing significant input. This may happen when the subject player character is traveling on a mount, watching a force be arrayed in battle, or the like. To minimize times when the user is not in control of the inputs, certain audio or video effects may be caused to happen during these times. In this way, since the user cannot control the camera anyway, it does not unduly disrupt gameplay to have the camera pan to a different angle or shot, etc.

The control module 910 drives various output modules to cause the enhanced effects. For example, the control module 910 drives an input to a music module 918 which results in music, changed by a musical effect, to be rendered by a sound renderer 934 such as a sound card. In the same way, the control module 910 drives an input to a sound effect module 922 which results in sound effects being rendered by the sound renderer 934. For video effects, the control module 910 drives an input to a main camera module 924 which results in camera effects being rendered by a video renderer 936, such as a video card. Also for video effects, the control module 910 drives an input to a procedural cut camera module 926 which results in special procedural cut effects, as described above, being rendered by the video renderer 936. Similarly, the control module 910 drives an input to a graphics module 928 which results in special effects, such as special screen effects as described above, being rendered by the video renderer 936. Rumble effects (i.e., a vibration of a control pad 938 or joystick) may also be rendered by a rumble module 932 by an appropriate input from the control module 910.

The number and type of such modules may vary significantly, and is only limited by the number and type of effects desired.

Referring to FIG. 10, a flowchart 900 is shown for the arrangement for enhancing audio or video effects, or both. In a first step, a default level of music, sound, and graphics may be rendered (step 942). In this respect it is noted that each level or zone may be associated with a default score or soundtrack. Battles or other combat, or any other action event, may also be associated with default scores or soundtracks. The default score or soundtrack then may change as players traverse levels, locations, zones, or the like. One implementation of the arrangement provides this changing background audio and video. A next step is to determine if a notable event has occurred, which may mean that an event has been recorded that matches a notable event in a table or database or that one of the monitored parameters or variables has reached a predetermined threshold (step 944). If no notable event has occurred, then the flow passes back to the initial step 942. If a notable event has occurred, however, then enhanced effects may be caused to be rendered (step 946). In some implementations, the enhanced effects may be rendered during a time in which user control of inputs is inhibited, removed, lessened, or minimized (step 948). For certain effects, they may be designed to complete just before control is regained by the player. For example, a camera may pan back to a default position.

The steps to the right of the dotted line in flowchart 900 illustrate examples of enhanced effects. These are in no way an exhaustive list. The number of enhanced effects is limited only by the imagination of the designer.

For example, if the input variables indicate that a subject player character has given or received damage (step 952), the music tempo may be quickened, and video effects may be provided (step 954). If the input variables indicate that a subject player character is close to death (step 956), the music may be altered so that less voices are heard, the music becomes ‘tinnier’, different instruments are played, or the like (step 958). If the input variables indicate that a subject player character is in battle with a number of opponents (step 962), the music tempo may be quickened, and the camera angle may be altered to include the opponents in the view (step 964). If the input variables indicate that a subject player character is fighting a particularly tenacious opponent (step 966), the background may be desaturated so that only the subject player character, the opponent, and blood effects are given color (step 968). If the input variables indicate that a subject player character is winning a battle (step 972), the current music may fade out and a triumphal score may blend or fade in (step 974). If the input variables indicate that a subject player character has changed levels or zones, or entered a dungeon or new instance (step 976), the music may change (step 978) to an appropriate score for the level, zone, dungeon, or instance. If the input variables indicate that a subject player character has delivered a decisive hit to an opponent (step 982), the procedural cuts module may cause the camera to cut to a slow-motion view of the decisive blow (step 984).

The above are but a few examples—numerous variations and combinations of the above, including variations in the various input data and output effects, may be employed, as well as variations may be employed in any combination.

While the above description has been described with respect to specific examples, it is to be understood that the invention is much broader than the disclosed examples. For example, while the arrangement has been described primarily with respect to video games, the same may be employed to enhance effects of any other type of application, including educational applications. While certain video effects have been described, other cinematic effects may also be employed, including skew shots, slow motion shots, depth of field manipulation, fogging, weather effects, and the like.

The present arrangement for enhancing audio or video effects-may be implemented in any number of computing systems, including laptop computers, desktop computers, tablet computers, handheld computers, personal digital assistants (“PDAs”), mobile phones, smart phones, game consoles, personal media players, handheld game devices, and the like.

And although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed in an electronic device, perform a method for enhancing video or audio effects, or both, in response to a notable event, the method comprising the steps of:
receiving data about action events occurring in a video game;
determining if an action event corresponds to a notable event; and
if the action event corresponds to a notable event, then using the received data to generate and render at least one audio or video effect, or both, corresponding to the notable event.

2. The computer-readable medium of claim 1 in which the received data includes an intensity parameter, a success parameter, a proximity of death parameter, or combinations thereof.

3. The computer-readable medium of claim 2 in which a notable event is an action event in which an intensity parameter, a success parameter, or a proximity of death parameter reaches a predetermined threshold.

4. The computer-readable medium of claim 2 in which a notable event is an action event which corresponds to a predetermined action.

5. The computer-readable medium of claim 4 in which a predetermined action is selected from the group consisting of: a subject player character attacking another character, a character attacking a subject player character, a subject player character entering a dungeon or instance, or a subject player character changing levels or zones.

6. The computer-readable medium of claim 1 in which using the received data to generate includes using the received data to select an audio or video effect from a library of audio or video effects.

7. The computer-readable medium of claim 1 in which the audio or video effect is an audio effect, and in which the audio effect is a change of a quality of a first musical score or a fade-in of a second musical score.

8. The computer-readable medium of claim 1 in which the audio or video effect is a video effect, and in which the video effect is a desaturation of color, a zoom of a camera angle, a change of color levels, or a recomposition of a scene.

9. The computer-readable medium of claim 8 in which the video effect is a recomposition of a scene to include a subject player character and at least one other character.

10. The computer-readable medium of claim 8 in which the proximity of death parameter is inversely proportional to a health of the subject player character.

11. The computer-readable medium of claim 2 in which the intensity parameter is proportional to a number of characters attacking a subject player character, their respective levels, and the level of the subject player character.

12. The computer-readable medium of claim 2 in which the success parameter is proportional to a level of damage caused by a subject player character.

13. The computer-readable medium of claim 1 in which using the received data to generate and render at least one audio or video effect includes rendering at least one video effect during a period of time in which user inputs are lessened or inhibited.

14. A system for enhancing video or audio effects, or both, of a video game in response to a notable event, comprising:
a music module to vary the music in a video game;
a camera module to vary a camera angle and zoom in the video game;
a graphics module to vary a color and quality of at least a portion of a game display; and
a controller to receive data corresponding to action in the video game, the controller configured such that in response to the data, the controller sends signals to the music module, the camera module, or the graphics module, or a combination thereof, to vary the audio and video rendering within the video game.

15. The system of claim 14 in which the data corresponds to an intensity of action surrounding a subject player character, a success in action of a subject player character, or a proximity to death of a subject player character.

16. The system of claim 14 further comprising a rumble module such that, in response to the data, the controller sends signals to the rumble module to cause vibration in a hand-held controller.

17. A computer-readable medium containing instructions which, when executed by one or more processors disposed in an electronic device, perform a method for enhancing video and audio effects, or both, in a video game, in response to a notable action event, the method comprising the steps of:
monitoring action data in a video game;
monitoring action events in a video game and comparing the monitored action events to a table of predetermined action events; and
in the event that the data reaches a predetermined threshold, or that an action event occurs that corresponds to a predetermined action event, then changing one or more of a musical score, a camera angle, a camera zoom, a camera composition, or a color saturation.

18. The computer-readable medium of claim 17 in which a musical score is changed, and in which a crescendo of the musical score occurs at substantially the same time as an action event.

19. The computer-readable medium of claim 17 in which the data corresponds to an intensity parameter, a success parameter, or a proximity to death parameter.

20. The computer-readable medium of claim 17 in which an action event corresponds to a predetermined action event, and further including a step of changing a camera angle to focus on the action event.
